(19) United States
(12) Patent Application Publication
(10) Pub. No.: US 2018/0351606 A1
(43) Pub. Date: Dec. 6, 2018

(54) ANTENNA ARRANGEMENT DETERMINATION DEVICE, ANTENNA ARRANGEMENT DETERMINATION METHOD AND WIRELESS COMMUNICATION DEVICE

(71) Applicant: KABUSHIKI KAISHA TOSHIBA, Tokyo (JP)

(72) Inventors: Daisuke UCHIDA, Kawasaki (JP); Daiki YODA, Yokohama (JP); Koji AKITA, Yokohama (JP); Tomoya TANDAI, Tokyo (JP)

(73) Assignee: KABUSHIKI KAISHA TOSHIBA, Tokyo (JP)

(21) Appl. No.: 15/918,254

(22) Filed: Mar. 12, 2018

(30) Foreign Application Priority Data
May 30, 2017 (JP) 2017-107009

(51) Int. Cl. H04B 7/04; H04B 7/0417

(52) U.S. Cl. CPC H04B 7/046; H04B 7/0617; H04B 7/0417

(57) ABSTRACT

According to one embodiment, an antenna arrangement determination device includes a candidate value generator, a calculator and an antenna arrangement determiner. The candidate value generator generates candidate values of a distance between a plurality of antennas, at an interval according to an installation height of an arbitrary one of the antennas, the distance between the antennas being adjustable. The calculator calculates communication quality in a case of setting the distance between the antennas at the candidate values. The antenna arrangement determiner determines a setting value of the distance between the antennas from the candidate values based on the communication quality.

### CROSS REFERENCE TO RELATED APPLICATIONS

This application is based upon and claims the benefit of priority from the prior Japanese Patent Application No. 2017-107009, filed on May 30, 2017, the entire contents of which are incorporated herein by reference.

### FIELD

Embodiments described herein relate to an antenna arrangement determination device, an antenna arrangement determination method and a wireless communication device.

### BACKGROUND

MIMO (Multiple Input, Multiple Output: MIMO) realizes multistream transmission that increases a transmission capacity by simultaneously using a plurality of antennas on both a transmission side and a reception side and performing wireless communication in the same frequency band. In MIMO, since radio waves transmitted by antennas on the transmission side (transmission antennas) reach antennas on the reception side (reception antennas) through a plurality of communication paths, reception signals of each reception antenna become composite waves of transmission signals of the plurality of transmission antennas. Therefore, it is needed to perform separation/detection processing of the transmission signals on the reception side in MIMO.

In a MIMO communication system for mobile communication so far, non-line-of-sight (NLOS) communication with a presence of a scattered radio wave propagation environment is assumed. That is, it is assumed that transmitted radio waves are reflected and scattered by the presence of an obstacle or the like existing in a communication path and reach a receiver in the form of a group of waves not correlated with each other. Therefore, the reception signals are separated/detected using a probabilistic model.

On the other hand, LOS (Line-of-Sight)-MIMO that increases a transmission capacity by performing MIMO so as to keep correlation low even in line-of-sight fixed point communication like a fixed microwave communication system is known. In LOS-MIMO, by adjusting a geometrical arrangement of the transmission antennas and the reception antennas, the transmission capacity can be increased.

For example, in a LOS-MIMO communication system which performs 2×2 MIMO with the presence of two each of the transmission antennas and the reception antennas, radio waves through a plurality of communication paths reach the reception antennas. It is known that, when a phase difference between the radio wave through a certain communication path and the radio wave through the other communication path is 90 degrees (π/2 radian), the transmission capacity becomes maximum. Even though a conditional expression of an antenna arrangement (a distance between antennas or the like) for obtaining such orthogonality or low spatial correlation is known, in the antenna arrangement specified from the conditional expression, the antenna may not be always arranged at the position due to a restriction of an installation environment or the like for a reason that an installation height is high. It is also conceivable to find an antenna arrangement which enables the low spatial correlation and actual installation by calculating the spatial correlation for all assumed antenna arrangements, but it is not practical since a computational load becomes huge. In addition, in an actual communication environment, the spatial correlation does not become zero even when the conditional expression is satisfied, and the antenna arrangement of lower spatial correlation may be present.

### BRIEF DESCRIPTION OF THE DRAWINGS

FIG. 1 is a diagram illustrating the whole of a wireless communication system according to a first embodiment;

FIG. 2 is a diagram illustrating a communication path relating to direct waves of the wireless communication system according to the first embodiment;

FIG. 3 is a diagram illustrating a communication path relating to ground reflected waves of the wireless communication system according to the first embodiment;

FIG. 4 is a diagram illustrating a relation between an antenna installation height and spatial correlation;

FIG. 5 is a block diagram of an antenna arrangement determination device on a transmission side according to the first embodiment;

FIG. 6 is a block diagram of an antenna arrangement determination device on a reception side according to the first embodiment;

FIG. 7 is a diagram of a spatial correlation map illustrating a result of simulating a relation among the antenna installation height, an antenna interval and the spatial correlation;

FIG. 8 is a diagram illustrating a case where part of a simulation result in FIG. 7 is enlarged;

FIG. 9 is a diagram extracting and illustrating a part of small spatial correlation in the spatial correlation map in FIG. 7;

FIG. 10 is a diagram extracting and illustrating a part of the small spatial correlation in a partially enlarged spatial correlation map in FIG. 8;

FIG. 11 is a diagram illustrating a method of selecting a candidate value of the antenna interval according to the first embodiment;

FIG. 12 is a diagram comparing the spatial correlation obtained in the case of applying a plurality of different sample interval values, in processing of selecting the candidate value of the antenna interval according to the first embodiment;

FIG. 13 is a diagram illustrating a cumulative probability distribution prepared from data in FIG. 12;

FIG. 14 is a diagram illustrating a processing flow of the antenna arrangement determination device according to the first embodiment;

FIG. 15 is a diagram illustrating an example of successively selecting the candidate value;

FIG. 16 is a diagram illustrating an example of a spatial correlation table according to the first embodiment;

FIG. 17 is a diagram illustrating another example of the spatial correlation table according to the first embodiment;

FIG. 18 is a block diagram of the antenna arrangement determination device on the reception side according to a second embodiment;

FIG. 19 is a diagram illustrating a transmission rate table according to the second embodiment;

FIG. 20 is a diagram illustrating the processing flow of the antenna arrangement determination device according to the second embodiment;

FIG. 21 is a diagram illustrating a positional relation of antennas on the transmission side and the reception side according to a third embodiment;

FIG. 22 is a diagram for illustrating a reflection route according to the third embodiment;

FIG. 23 is a diagram illustrating an example of considering frequency selective fading in a fourth embodiment;

FIG. 24 is a diagram illustrating a case where the number of the antennas is three or larger in a fifth embodiment;

FIG. 25 is a diagram illustrating a graph connecting points of minimum spatial correlation calculated for each antenna installation height; and

FIG. 26 is a diagram illustrating an example of approximating the graph in FIG. 25 by a quadratic function.

### DETAILED DESCRIPTION

According to one embodiment, an antenna arrangement determination device includes a candidate value generator, a calculator and an antenna arrangement determiner. The candidate value generator generates candidate values of a distance between a plurality of antennas, at an interval according to an installation height of an arbitrary one of the antennas, the distance between the antennas being adjustable. The calculator calculates communication quality in a case of setting the distance between the antennas at the candidate values. The antenna arrangement determiner determines a setting value of the distance between the antennas from the candidate values based on the communication quality.

Hereinafter, embodiments of the present invention will be described with reference to the drawings. In addition, for same components in the drawings, identical numbers are attached and description is appropriately omitted.

### First Embodiment

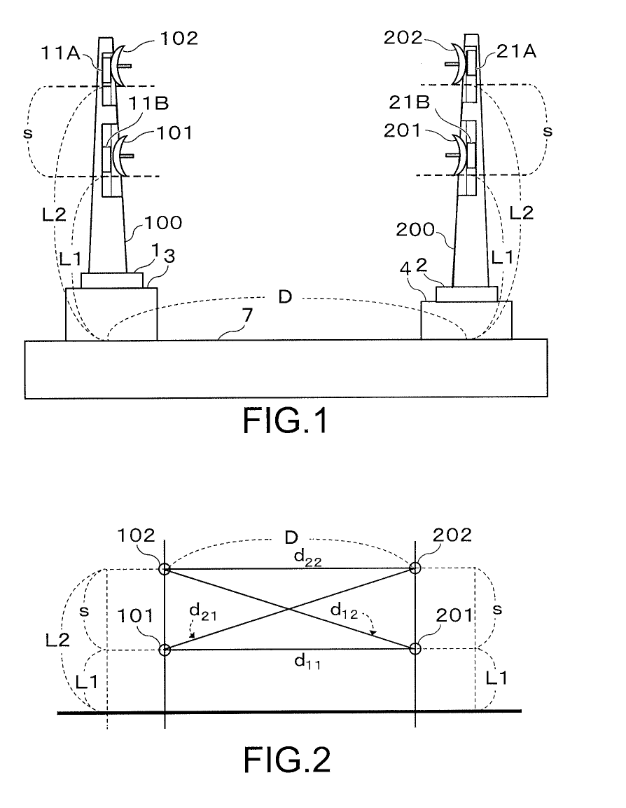

FIG. 1 is a diagram schematically illustrating an entire configuration of a LOS (Line-Of-Sight)-MIMO (Multiple Input, Multiple Output: MIMO) system according to the first embodiment. The MIMO communication system includes a transmission station which is a communication station and a reception station which is a communication station. The transmission station includes an array antenna device (antenna device, hereinafter) 100 and an antenna arrangement determination device 1. The reception station includes an antenna device 200 and an antenna arrangement determination device 2. The transmission station is installed on an arbitrary installation base 3, and the reception station is installed on an arbitrary installation base 4. Examples of the installation bases 3 and 4 are positions higher than ground 7 such as a rooftop of a building, a hilltop or a ridge of a mountain chain. However, the installation bases 3 and 4 may be the ground. By the arrangement at high positions, the line of sight is secured with each other for the antenna devices 100 and 200, and radio waves are prevented from being interrupted by surrounding structures or ground unevenness or the like.

The antenna devices 100 and 200 are arranged so as to face each other in a line-of-sight environment. The antenna device 100 on a transmission side includes two antennas 101 and 102 which transmit and receives radio waves, and the antennas 101 and 102 are array antennas arranged at an interval from each other in a vertical direction to the ground. The antennas 101 and 102 are configured movably in respectively predetermined ranges in the vertical direction to the ground. Thus, relative positions of the antennas 101 and 102 are movable. The antenna device 200 on a reception side includes two antennas 201 and 202 which transmit and receives radio waves, and the antennas 201 and 202 are array antennas arranged at an interval from each other in the vertical direction to the ground. The antennas 201 and 202 are configured movably in respectively predetermined ranges in the vertical direction to the ground respectively. Thus, relative positions of the antennas 201 and 202 are movable. In the figure, a parabolic antenna is illustrated as the antenna, but it is just an example, and the antenna may be of other kinds such as a horn antenna. Further, the configuration that the plurality of antennas of different kinds are combined is not excluded.

A distance between the antenna device 100 on the transmission side and the antenna device 200 on the reception side is “D”. The distance is referred to as a transmission/reception distance “D”. The antennas 101 and 102 on the transmission side and the antennas 201 and 202 on the reception side are arranged so as to be in a linearly symmetrical relation with each other for a symmetry axis vertical to the ground, during data transmission/reception. However, such a linearly symmetrical arrangement is not an essential requirement.

The antenna 102 is arranged at a height L2 to the ground. The antenna 202 facing the antenna 102 is also at the height L2 to the ground. Hereinafter, the height L2 is referred to as an antenna installation height L2 in particular. The antenna 101 is arranged at a height L1 to the ground. The antenna 201 facing the antenna 101 is also at the height L1 to the ground.

Hereinafter, the height L1 is referred to as an antenna installation height L1 in particular. A distance (interval) between the antenna 101 and the antenna 102 is “s”. Since the antennas 101 and 102 are arranged vertically to the ground, the distance (interval) “s” is |L2−L1|. Hereinafter, the distance (interval) “s” is referred to as an antenna interval “s”. Since it is the linearly symmetrical arrangement here, the antenna interval between the antennas 201 and 202 is also the same antenna interval “s” as the transmission side. While it is considered that the ground is flat here, it is not limited thereto. In the case where the transmission station and the reception station are arranged at different heights of the ground, an average height of the heights of the ground where the stations are respectively installed may be turned to a reference of the antenna installation height.

The antennas 101 and 102 are electrically connected with the antenna arrangement determination device 1. Since the antenna arrangement determination device 1 according to the embodiment of the present invention has a function of performing wireless data communication, the antenna arrangement determination device 1 sends one of two transmission signals generated for MIMO transmission to the antenna 101, and sends the other to the antenna 102, and radio waves of the same wavelength λ, that is, the same frequency is emitted from the antenna 101 and the antenna 102. Note that the wavelength λ and a frequency “f” are in the relation of c=2f when a light speed is “c”.

The transmission station includes drivers 11A and 11B arranged respectively to the antenna 101 and the antenna 102. The drivers 11A and 11B move the corresponding antenna of the antenna 101 and the antenna 102 in a fixed range in the vertical direction to the ground. As a realization method of a moving mechanism by the drivers 11A and 11B, a motor-driven actuator, an air pressure actuator, a hydraulic actuator or a combination of a wire, a belt, a chain, a gear, a wheel and a rail or the like and a power tool are assumed, but the method to be used does not matter as long as a linear motion is possible. While the drivers 11A and 11B are arranged at the back of the antenna 101 and the antenna 102 in FIG. 1, the position and the configuration of the drivers 11A and 11B are not limited thereto. For example, the configuration may be such that the drivers 11A and 11B are arranged at the base of the antenna device 100. In addition, while the positions of both antennas 101 and 102 are movable in FIG. 1, only one of them may be movable. In that case, one of the drivers 11A and 11B is not needed.

Also on the reception side, drivers 21A and 21B are arranged respectively to the antenna 201 and the antenna 202. The drivers 21A and 21B move the corresponding antenna of the antenna 201 and the antenna 202 in the fixed range. The position and the configuration examples of the drivers 21A and 21B are similar to those of the drivers 11A and 11B.

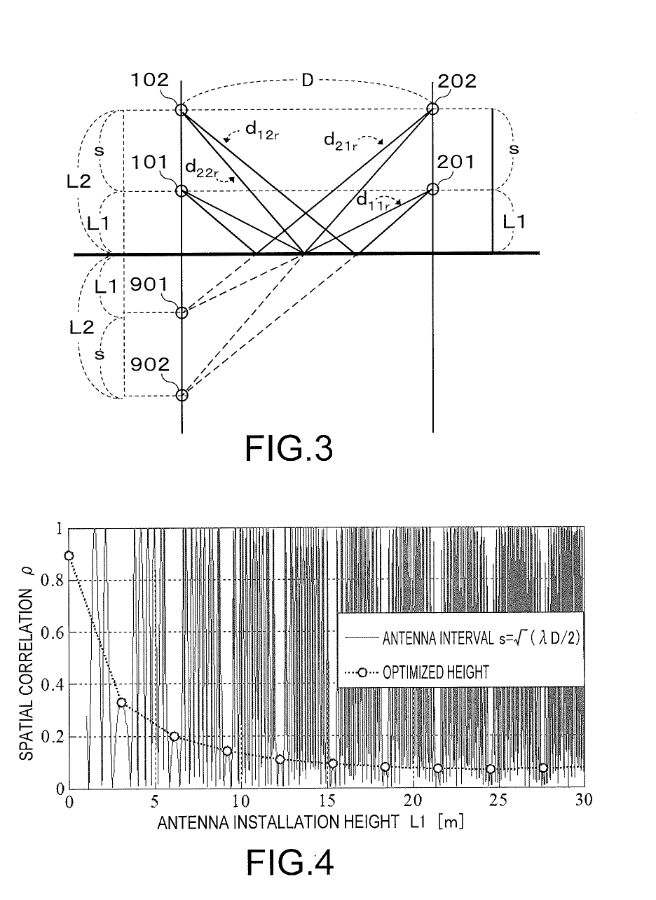

FIG. 2 illustrates a deterministic communication path of direct waves transmitted by the antenna device 100 and received by the antenna device 200. FIG. 3 illustrates a deterministic communication path of ground reflected waves transmitted by the antenna device 100 and received by the antenna device 200. FIG. 3 also illustrates virtual antennas 901 and 902 arranged at positions symmetrical to the ground regarding the antennas 101 and 102 in order to calculate a route of the ground reflected waves. The communication paths illustrated in FIG. 2 and FIG. 3 are also established even in the case where the relation of the transmission side/reception side of the antenna device 100 and the antenna device 200 is switched. In the case of assuming the deterministic communication paths, it is known as a related technology that orthogonality of the communication path can be secured and spatial correlation can be suppressed when the antenna interval “s” in each of the antenna devices 100 and 200 is set to √(λD/2) as an example. Hereinafter, this will be described first in detail.

As in FIG. 2, a deterministically determined path of the direct waves is considered, and a path length is placed as dᵢⱼ, respectively. The sign dᵢⱼ indicates a length of the path of the direct waves from an antenna “j” on the transmission side to an antenna “i” on the reception side. As in FIG. 3, a deterministically determined path of the ground reflected waves is considered, and a path length is placed as dᵢⱼᵣ. The sign dᵢⱼᵣ indicates a length of the path of the ground reflected waves from the antenna “j” on the transmission side to the antenna “i” on the reception side. Note that, in the case that the antenna interval “s” in each of the antenna devices 100 and 200 is sufficiently short compared to the transmission/reception distance “D”, a difference in an amplitude of reception signals between the antennas on the reception side can be neglected.

Here, a MIMO system model in which the number of the antennas on the transmission side (transmission antennas) is Nₜₓ and the number of the antennas on the reception side (reception antennas) is Nᵣₓ is considered. When a channel response (channel information) from a j-th transmission antenna to an i-th reception antenna is indicated by hᵢⱼ, it can be expressed as follows.

$$[ \begin{matrix}{y}_{i} ( t ) \\ ⋮ \\ {y}_{{N}_{rx}}\end{matrix} ] = [ \begin{matrix}{h}_{i 1} & … & {h}_{{iN}_{rx}} \\ ⋮ & ⋱ & ⋮ \\ {h}_{{N}_{rx} i} & … & {h}_{{N}_{rx} {N}_{tx}}\end{matrix} ] [ \begin{matrix}{x}_{i} ( t ) \\ ⋮ \\ {x}_{{N}_{rx}}\end{matrix} ] + [ \begin{matrix}{z}_{i} ( t ) \\ ⋮ \\ {z}_{{N}_{rx}} ( t )\end{matrix} ] . \qquad ( 1 )$$

The element hᵢⱼ includes an amplitude attenuation amount and a phase rotation of a pertinent channel (communication path) as information. Here, xᵢ(t) denotes a transmission signal of a transmission antenna Nᵢ, yᵢ(t) denotes a reception signal of a reception antenna Nᵢ, and zᵢ(t) denotes noise received by the reception antenna Nᵢ.
When an Nᵣₓ×Nₜₓ-dimensional matrix formed of the element hᵢⱼ is defined as a channel matrix “H”, the expression (1) is formulated as follows.

y(t)=Hx(t)+z(t) (2)

In the present embodiment, since two antennas are provided both on the transmission side and on the reception side, a 2×2 MIMO system model is applied. Therefore, the channel matrix “H” becomes 2×2 dimensional. The elements of the channel matrix “H” are expressed by addition of phase components of the direct waves and the ground reflected waves as follows.

$$H = [ \begin{matrix}{e}^{- {jkd}_{11}} + A {e}^{- {jkd}_{11 r}} & {e}^{- {jkd}_{12}} + A {e}^{- {jkd}_{12 r}} \\ {e}^{- {jkd}_{21}} + A {e}^{- {jkd}_{21 r}} & {e}^{- {jkd}_{22}} + A {e}^{- {jkd}_{22 r}}\end{matrix} ] \qquad ( 3 )$$

Here, “A” denotes a reflection coefficient of the ground reflected waves, “j” denotes an imaginary unit, and “k” denotes a wave number (2λ/λ).

Using a spatial correlation matrix in the expression (3),

$${HH}^{H} = [ \begin{matrix}{e}^{- {jkd}_{11}} + A {e}^{- {jkd}_{11 r}} & {e}^{- {jkd}_{12}} + A {e}^{- {jkd}_{12 r}} \\ {e}^{- {jkd}_{21}} + A {e}^{- {jkd}_{21 r}} & {e}^{- {jkd}_{22}} + A {e}^{- {jkd}_{22 r}}\end{matrix} ] [ \begin{matrix}{e}^{{jkd}_{11}} + A {e}^{{jkd}_{11 r}} & {e}^{{jkd}_{21}} + A {e}^{{jkd}_{21 r}} \\ {e}^{{jkd}_{12}} + A {e}^{{jkd}_{12 r}} & {e}^{{jkd}_{22}} + A {e}^{{jkd}_{22 r}}\end{matrix} ] \qquad ( 4 )$$

can be defined. HH^{H} is a 2×2 matrix. As an orthogonality condition of the channel, expressions that two nondiagonal elements in HH^{H} respectively coincide with 0 are set. When the expressions are solved, relational expressions (5) to (12) below are derived.

$$\begin{matrix}( {d}_{11} - {d}_{21} ) - ( {d}_{12} - {d}_{22} ) = - \frac{λ}{2} ( 2 {p}_{1} + 1 ) & ( 5 ) \\ ( {d}_{22 r} - {d}_{21 r} ) - ( {d}_{12} - {d}_{11} ) = - \frac{λ}{2} ( 2 {p}_{2} + 1 ) & ( 6 ) \\ ( {d}_{11 r} - {d}_{12 r} ) - ( {d}_{21} - {d}_{22} ) = - \frac{λ}{2} ( 2 {p}_{3} + 1 ) & ( 7 ) \\ ( {d}_{11 r} - {d}_{21 r} ) - ( {d}_{12 r} - {d}_{22 r} ) = - \frac{λ}{2} ( 2 {p}_{4} + 1 ) & ( 8 ) \\ ( {d}_{21} - {d}_{21 r} ) - ( {d}_{11} - {d}_{11 r} ) = \frac{λ}{2} \times 2 {p}_{5} & ( 9 ) \\ ( {d}_{21} - {d}_{21 r} ) - ( {d}_{11} - {d}_{11 r} ) = \frac{λ}{2} \times 2 {p}_{6} & ( 10 ) \\ ( {d}_{22} - {d}_{22 r} ) - ( {d}_{12} - {d}_{12 r} ) = \frac{λ}{2} \times 2 {p}_{7} & ( 11 ) \\ ( {d}_{22} - {d}_{22 r} ) - ( {d}_{12} - {d}_{12 r} ) = \frac{λ}{2} 2 {p}_{8} & ( 12 )\end{matrix}$$

The sign pᵢ denotes a positive or negative arbitrary integer. In order for terms of

e^{jk(d}^{₁₁}^{-d}^{₂₁}⁾
and
e^{jk(d}^{₁₂}^{-d}^{₂₂}⁾
to cancel each other and become 0, the expression (5) is derived by a relation that a difference of an argument on complex space becomes π±2nπ (n is a positive integer). The expressions (6) to (12) are also derived by the similar relation.

The expression (5) becomes the orthogonality condition of the direct waves, the expression (8) becomes the orthogonality condition of the ground reflected waves, and the expressions (6) and (7) and the expressions (9) to (12) become the orthogonality condition between the direct waves and the reflected waves.

By a positional relation illustrated in FIG. 3, dᵢⱼᵣ can be expressed as expressions (13) to (15) below using the antenna installation heights L1 and L2 and the transmission/reception distance “D”.

$$\begin{matrix}{d}_{11 r} = \sqrt{{D}^{2} + {( 2 \cdot L 1 )}^{2}} = D {\{ 1 + {( \frac{2 \cdot L 1}{D} )}^{2} \}}^{1 / 2} & ( 13 ) \\ {d}_{22 r} = \sqrt{{D}^{2} + {( 2 \cdot L 2 )}^{2}} = D {\{ 1 + {( \frac{2 \cdot L 2}{D} )}^{2} \}}^{1 / 2} & ( 14 ) \\ {d}_{12 r} = {d}_{21 r} = \sqrt{{D}^{2} + {( L 1 + L 2 )}^{2}} = D {\{ 1 + {( \frac{L 1 + L 2}{D} )}^{2} \}}^{1 / 2} & ( 15 )\end{matrix}$$

In the expression (13), when it is assumed that the transmission/reception distance “D” is sufficiently long in comparison with L1, it is 1>>(2×L1/D)² so that the following approximate expression is established.

$${d}_{11 r} \approx D \{ 1 + \frac{1}{2} {( \frac{2 \cdot L 1}{D} )}^{2} \} = D + \frac{1}{2} \frac{{( 2 \cdot L 1 )}^{2}}{D} \qquad ( 16 )$$

Under the similar assumption, it is 1>>(2×L2/D)² in the expression (14) and it is 1>>{(L1+L2)/D}² in the expression (15) so that the following approximate expressions are established.

$$\begin{matrix}{d}_{22 r} \approx D \{ 1 + \frac{1}{2} {( \frac{2 \cdot L 2}{D} )}^{2} \} = D + \frac{1}{2} \frac{{( 2 \cdot L 2 )}^{2}}{D} & ( 17 ) \\ {d}_{12 r} = {d}_{21 r} \approx D \{ 1 + \frac{1}{2} {( \frac{L 1 + L 2}{D} )}^{2} \} = D + \frac{1}{2} \frac{{( L 1 + L 2 )}^{2}}{D} & ( 18 )\end{matrix}$$

When the expressions (16) to (18) above are substituted in the expression (8) which is the orthogonality condition of the ground reflected waves,

$$\frac{{( L 2 - L 1 )}^{2}}{D} = - \frac{λ}{2} ( 2 {p}_{4} + 1 ) \qquad ( 19 )$$

is obtained. Here, when p₄=−1 is selected, the expression (20) below is derived.

$$s = L 2 - L 1 = \pm \sqrt{\frac{λ D}{2}} \qquad ( 20 )$$

The expression (20) expresses the antenna interval “s” satisfying the orthogonality condition for the ground reflected waves. Here, since it is L2>L1 (L2−L1>0), it is s=√(λD/2).

In addition, when it is assumed that the transmission/reception distance “D” is sufficiently long in comparison with the antenna interval “s”, for the communication path of the direct waves, the following expression (21) is obtained.

$${d}_{12} = {d}_{21} = \sqrt{{D}^{2} + {s}^{2}} = D {\{ 1 + {( \frac{s}{D} )}^{2} \}}^{1 / 2} \approx D + \frac{1}{2} \frac{{s}^{2}}{D} \qquad ( 21 )$$

When the expression (21) above is substituted in the expression (5) which is the orthogonality condition of the direct waves, the following expression (22) is obtained.

$$- D = - \frac{λ}{2} ( 2 {p}_{1} + 1 ) \qquad ( 22 )$$

When p₁=0 is selected here, a relational expression of the antenna interval s=√(λD/2) satisfying the orthogonality condition of the direct waves is derived. It is the same as the relational expression of the antenna interval satisfying the orthogonality condition of the ground reflected waves, which is calculated by the expression (20).

Next, when the approximate expressions (16), (18) and (21) are substituted in the expression (9) including the orthogonality condition between the direct waves and the ground reflected waves, the following expression (23) is obtained.

$$- L 1 \cdot s = \frac{λ D}{2} {p}_{6} \qquad ( 23 )$$

As described above, in the case that the orthogonality condition of the direct waves and the orthogonality condition of the ground reflected waves are satisfied, since the relation of s=√(λD/2) is established for the antenna interval, when the “s” is substituted in the expression (23),

$$L 1 = - \sqrt{\frac{λ D}{2}} {p}_{6} \qquad ( 24 )$$

is attained.

In addition, from the expression (24), s=√(λ2D/2), and L2=L1+s, the following expression is obtained.

$$L 2 = \sqrt{\frac{λ D}{2}} - \sqrt{\frac{λ D}{2}} {p}_{6} \qquad ( 25 )$$

Since p₆ is a positive or negative arbitrary integer and L2 is positive, a candidate of the installation height L2 of the antennas 102 and 202 needs to be a value for which an integral multiple of √(λD/2) is added to √(λD/2) as in the expression (25). In addition, a candidate of the installation height L1 of the antennas 101 and 201 needs to be the integral multiple of √(λD/2). That is, the candidate of the installation height L2 is √(λD/2) interval, and the candidate of the installation height L1 is also √(λD/2) interval. At the installation height L2 satisfying the expression (25), in addition to satisfaction of the orthogonal relation of the direct waves with each other and the orthogonal relation of ground waves with each other, a condition that the direct waves and the ground waves are orthogonal to each other is satisfied. That is, in the case that the expression (25) is satisfied, it is derived according to calculations that the orthogonality of the communication paths is secured (the spatial correlation is zero or is suppressed).

FIG. 4 illustrates a relation between the antenna installation height L1 and spatial correlation p prepared by simulation by the inventors. Note that a definition of the spatial correlation p will be described later. It is defined that D=5000 m and f=80 GHz, and a channel configured by two waves of the direct wave and the reflected wave is generated based on the Friis transmission formula. It is defined that s=√(λD/2). A graph of a solid line is the graph for which points expressing the spatial correlation calculated by the simulation for each antenna installation height L2 within a predetermined range are connected. Each circle in the figure expresses the antenna installation height (optimized height) L2 in the case of satisfying the expression (25) and the spatial correlation at the time. For L2 larger than 0, the value of the spatial correlation p is suppressed to be small (however, the spatial correlation does not become 0 even in the case of satisfying the expression (25) due to influence by the reflection coefficient of the reflected waves or the like in the simulation). As illustrated by the graph, at the antenna installation height L2 not satisfying the expression (25), the value of the spatial correlation p is not stable between 0.0 and 1.0. On the other hand, at the antenna installation height L2 satisfying the expression (25), the spatial correlation can be suppressed to be small. However, the interval of such an installation height L2 is large. This constrains a height of a building to install the antenna device and adjustment of the installation height L2 after installation. Even at the height other than the antenna installation height L2 satisfying the expression (25), reduction of the spatial correlation is required. In addition, even in the case that the installation at the antenna installation height L2 satisfying the expression (25) is possible, lower spatial correlation may be obtained at the antenna installation height L2 different from the antenna installation height L2 satisfying the expression (25) (the antenna installation height slightly lower than the antenna installation height L2 satisfying the expression (25)) in actual communication.

Then, in the present embodiment, other than the antenna installation height L2 or L1 satisfying the expression (25), the antenna installation height L2 or L1 capable of reducing the spatial correlation is efficiently found.

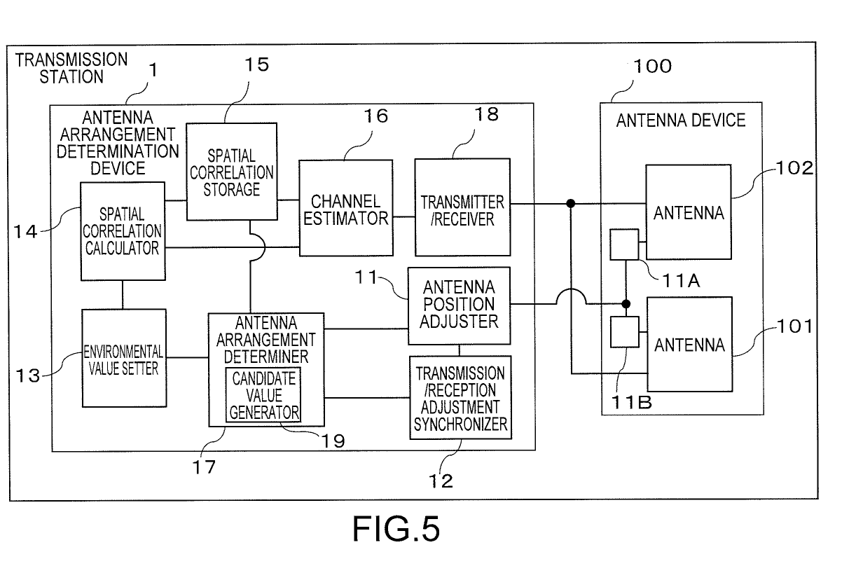

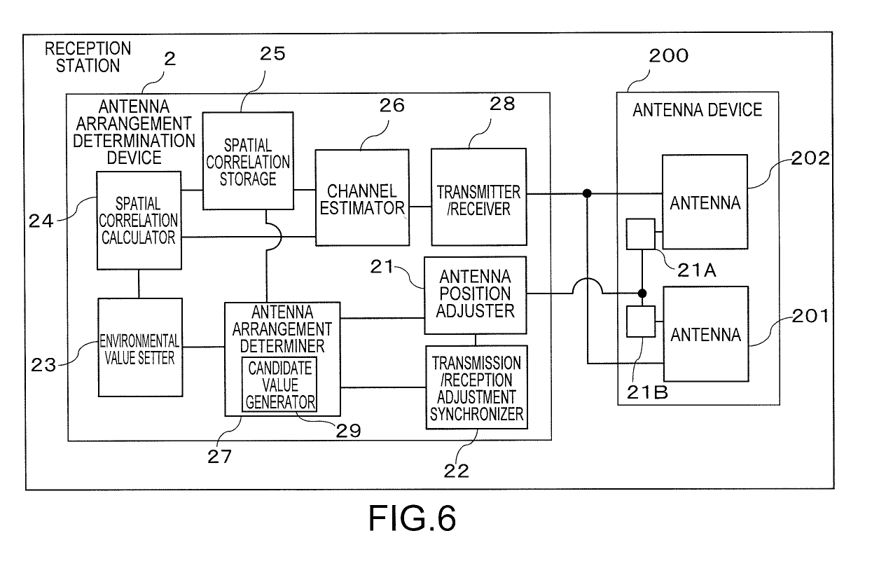

Hereinafter, the transmission station (the antenna arrangement determination device 1 and the antenna device 100) and the reception station (the antenna arrangement determination device 2 and the antenna device 200) in FIG. 1 will be described further in detail. FIG. 5 is a detailed block diagram of the transmission station according to the first embodiment. FIG. 6 is a detailed block diagram of the reception station according to the first embodiment.

The transmission station in FIG. 5 includes the antenna arrangement determination device 1 and the antenna device 100. The antenna arrangement determination device 1 includes an antenna position adjuster 11, a transmission/reception adjustment synchronizer 12, an environmental value setter 13, a spatial correlation calculator 14, a spatial correlation storage 15, a channel estimator 16, an antenna arrangement determiner 17, a transmitter/receiver 18, and a candidate value generator 19. The antenna device 100 includes the antennas 101 and 102, and the drivers 11A and 11B which move the antennas 101 and 102. All or part of the respective sections 11 to 14 and 16 to 19 may be realized by software by making a processor such as a CPU execute a program, may be realized by an exclusive hardware circuit or a programmable circuit, or may be realized by both.

The reception station in FIG. 6 includes the antenna arrangement determination device 2 and the antenna device 200. The antenna arrangement determination device 2 includes an antenna position adjuster 21, a transmission/reception adjustment synchronizer 22, an environmental value setter 23, a spatial correlation calculator 24, a spatial correlation storage 25, a channel estimator 26, an antenna arrangement determiner 27, a transmitter/receiver 28, and a candidate value generator 29. The antenna device 200 includes the antennas 201 and 202, and the drivers 21A and 21B which move the antennas 201 and 202. All or part of the respective sections 21 to 24 and 26 to 29 may be realized by software by making a processor such as a CPU execute a program, may be realized by an exclusive hardware circuit or a programmable circuit, or may be realized by both.

The configuration of the antenna position determination device according to the embodiment of the present invention is an example, and a configuration different from that may be used. The antenna arrangement determination device includes at least a component that calculates communication quality such as a spatial correlation calculator, a candidate value generator, and an antenna arrangement determiner. Therefore, the antenna arrangement determination device may be realized by an information processor such as a computer independent of the wireless communication device. The antenna arrangement determination device can have a function of changing an antenna position to a determined arrangement such as an antenna position adjuster further. In such a case, the antenna arrangement determination device is combined with the existing wireless communication device and antenna device, and a MIMO communication system capable of high quality communication can be constructed. In addition, like the embodiment of the present invention, the antenna arrangement determination device may have the configuration integrated with the wireless communication device by including components for wireless data communication such as a channel estimator and a transmitter/receiver. In this case, it can be said that the wireless communication device serves also as the antenna arrangement determination device. The configurations of the antenna arrangement determination device relating to the transmission station and the reception station do not need to be identical, and may be respectively different configurations.

The transmitter/receiver 18 and the transmitter/receiver 28 perform wireless communication with each other. The transmitter/receiver 18 and the transmitter/receiver 28 perform modulation such as MIMO modulation, DA conversion, up-conversion to a radio frequency, and amplification or the like during transmission. The transmitter/receiver 18 and the transmitter/receiver 28 perform amplification, down-conversion, AD conversion, and demodulation such as MIMO demodulation during reception. A communication scheme to be used may be arbitrary.

The transmitter/receiver 18 of a transmission station 1 generates modulated signals by modulating carrier waves based on signals for transmission. The modulated signals are DA-converted, up-converted to the radio frequency, amplified or the like, and transmitted through one or a plurality of antennas. Note that, for a modulation scheme, an arbitrary digital modulation scheme such as ASK (Amplitude Shift Keying), PSK (Phase Shift Keying), FSK (Frequency Shift Keying), or QAM (Quadrature Amplitude Modulation) may be used. Note that not the digital modulation scheme but an analog modulation scheme such as amplitude modulation (AM), frequency modulation (FM) or phase modulation (PM) can be used. In addition, the transmitter/receiver 18 includes a function of executing MIMO. In the case of performing MIMO, the transmitter/receiver 18 generates a plurality of streams by dividing data, performs the MIMO modulation to the plurality of streams, and then transmits the modulated streams from the plurality of antennas.

Further as needed, the transmitter/receiver 18 may perform secondary modulation. As a secondary modulation scheme, any scheme may be used, such as DS (Direct Sequence), FH (Frequency Hopping), TDMA (Time Division Multiple Access), FDMA (Frequency Division Multiple Access), CDMA (Code Division Multiple Access) or OFDM (Orthogonal Frequency-Division Multiplexing). In addition, the transmitter/receiver 18 may perform the communication by an arbitrary multiplex scheme such as time division multiplex, frequency division multiplex, code division multiplex or a combination thereof.

The transmitter/receiver 28 of a reception station 2 receives the radio waves transmitted from the transmission station through one or a plurality of antennas, and performs low noise amplification, down-conversion, AD conversion and demodulation to the signals of the received radio waves. In the case of MIMO, the transmitter/receiver 28 receives the radio waves transmitted from the transmission station 1 by the plurality of antennas, and separates the signals received by the plurality of antennas into the plurality of streams by performing MIMO demodulation. For a signal separation algorithm in MIMO demodulation processing, while there are a plurality of schemes such as a ZF method (Zero-Forcing method), an MMSE method (Minimum Mean Square Error method), a BLAST method (Bell Laboratories Layered Space-Time method), an MLD method (Maximum Likelihood Detection method) or a derivation of the MLD method, any scheme of them may be used.

Roles of the transmission station and the reception station can be replaced with each other. In this case, the transmitter/receiver 18 of the transmission station 1 executes processing similar to that of the transmitter/receiver 28 of the reception station 2 described above. On the other hand, the transmitter/receiver 28 of the reception station 2 executes the processing similar to that of the transmitter/receiver 18 of the transmission station 1 described above. Both of the transmission station 1 and the reception station 2 can function as a transmission/reception station having the functions of both transmission and reception.

The antenna position adjuster 11 adjusts the positions of the antennas 101 and 102 by controlling the drivers 11A and 11B. The antenna position adjuster 11 fixes the antennas at the adjusted positions. By fixation, even when there are winds, fluctuations of an air temperature, vibrations or the like generated during outdoor use, a position shift of the antenna 101 and the antenna 102 is suppressed. The antenna position adjuster 11 adjusts the positions of the antenna 101 and the antenna 102 based on at least one of the antenna interval “s” and the antenna installation heights L1 and L2, as an example. The values are provided from the antenna arrangement determiner 17.

The antenna position adjuster 21 of the reception station 2 also adjusts the positions of the antenna 201 and the antenna 202 by controlling the antenna 201 and the antenna 202 based on at least one of the antenna interval “s” and the antenna installation heights L1 and L2 similarly. The antenna position adjuster 21 fixes the antennas at the adjusted positions.

The transmission/reception adjustment synchronizer 12 performs synchronization processing of setting of the antenna interval “s” and setting of the antenna installation heights L1 and L2 with the transmission/reception adjustment synchronizer 22 on the reception side. The synchronization processing is to perform the setting so that the antenna interval “s” and the antenna installation heights L1 and L2 used by the antenna position adjuster 21 of the reception station 2 become the same as the values used by the antenna position adjuster 11 of the transmission station 1. Also for the transmission/reception adjustment synchronizer 22 of the reception station 2, by performing the synchronization processing with the transmission/reception adjustment synchronizer 12 on the transmission side, the antenna interval “s” and the antenna installation heights L1 and L2 used on the transmission side can be set to be the same as the values used on the reception side.

The transmission/reception adjustment synchronizers 12 and 22 may perform the synchronization processing by the wireless communication through the transmitter/receivers 18 and 28 or, in the case that there is a wired network connecting the transmission station 1 and the reception station 2, by wired communication using the wired network.

The environmental value setter 13 holds parameters. The parameters include all or part of the transmission/reception distance “D”, a wavelength; or a frequency “f” of radio waves, a range [Lₗ, Lₕ] of the installation height L1 of the antenna 101, a range [Nₗ, Nₕ] of the installation height L2 of the antenna 102, and a range [sₗ, sₕ] of the antenna interval. The environmental value setter 13 may include a buffer for holding the parameters inside. The buffer is configured from one of a nonvolatile storage device such as a NAND flash memory, a NOR flash memory, an MRAM, a ReRAM, a hard disk or an optical disc or a storage device such as a DRAM or a combination thereof.

A method of acquiring the parameters is not limited in particular. The parameters may be statically registered to the environmental value setter 13 from outside beforehand, or the environmental value setter 13 may calculate the parameters by measurement and hold the calculated parameters inside.

An example of calculating the parameters by the measurement will be described. For the transmission/reception distance “D”, there is a method of performing the measurement between the transmission station and the reception station and obtaining the value of the transmission/reception distance “D”. For example, it is possible to use a positioning method such as GPS (Global Positioning System) to obtain the positions of the transmission station and the reception station, calculate a distance between them, and use it as the transmission/reception distance “D”. The time that light goes and comes back between the transmission station and the reception station may be measured like Time-of Flight (TOF), the distance may be calculated from the measured time and a light speed, and it may be used as the transmission/reception distance “D”.

For the antenna installation height L1 or L2, there are a method of obtaining the installation height from an atmospheric pressure sensor, a method of obtaining the installation height from information regarding a height of a building where the antenna device is installed, and a method of performing the measurement by Time-of-Flight (TOF) with a spot, a height of which is known, and calculating the antenna installation height from the difference, or the like.

As a method of setting the parameters from the outside, a value inputted by a user such as a worker may be registered to the environmental value setter 23. Or, the value distributed from a management server not illustrated may be acquired and registered to the environmental value setter 23 as the parameter. In these cases, an interface used for inputting the value or an instruction to the antenna arrangement determination devices 1 and 2 may be a physical terminal such as a console with an input key or a touch panel, a web interface operable from a browser, or an API (Application Programming Interface) realized by software. In addition, a place where an actual input operation is performed may be a location of the transmission station 1 or the reception station 2, or may be a remote environment away from an installation place of the transmission station 1 or the reception station 2. In the case where input from the remote environment is performed, transmission may be performed through a telecommunication line or a management server or the like between the terminal and the transmission station or the reception station.

The channel estimator 26 obtains the channel matrix “H” of the expression (2) (channel estimation). The channel estimator 26 performs the channel estimation based on the signals received from the transmission station. However, by assuming symmetry of the communication path between the transmission station 1 and the reception station 2, the channel estimator 16 may perform the channel estimation based on the signals received from the reception station. The channel estimation can be similarly performed even in the case that the transmission station is operated as the reception station and the reception station is operated as the transmission station.

Here, an operation of the channel estimator 26 will be described. First, the transmitter/receiver 18 of the transmission station transmits pilot signals which are signals for the channel estimation to the antenna device 200 using the antennas 101 and 102 of the antenna device 100. The pilot signals include signals arranged discretely to the time and the frequency, and a pattern of the pilot signals is shared between the transmission station 1 and the reception station 2 beforehand. The pilot signals may be transmitted by the reception station transmitting transmission instruction signals of the pilot signals to the transmission station. The reception station performs the operation in the case that start of antenna adjustment processing is determined as an example. The antenna adjustment processing may be performed when instruction information of a user is received from the outside, may be periodically performed, or may be performed in the case where decline of the communication quality is detected (for example, the case where a reception error rate becomes a fixed value or higher).

The pilot signals transmitted from the transmission station are received by the transmitter/receiver 28 of the reception station through the antennas 201 and 202 of the antenna device 200. The received signals are delivered from the transmitter/receiver 28 to the channel estimator 26. The channel estimator 26 applies two-dimensional linear interpolation or interpolation using two-dimensional discrete Fourier transform or the like to the received signals, and estimates the channel matrix “H”. The interpolation method for the time of the channel estimation described here is an example, and other methods such as fast Fourier transform may be used.

The spatial correlation calculator 24 of the reception station calculates the spatial correlation using the channel matrix “H” obtained in the channel estimator 26. In MIMO communication, since obstacles such as ground unevenness and a structure are present, scattering of the radio waves occurs. Therefore, respective channels are not independent of each other, and correlated to a certain extent. Such inter-channel correlation is referred to as the spatial correlation. Here, reception spatial correlation defined by expressions (26) and (27) below

ρᵣ
is calculated.

$$\begin{matrix}{R}_{r} = E [ {HH}^{H} ] & ( 26 ) \\ {ρ}_{r} = \frac{{R}_{r , ij}}{\sqrt{{R}_{r , ii} {R}_{r , jj}}} & ( 27 )\end{matrix}$$

Here, E[●] is a time average operation. The signs Rr, ij indicate ij components of Rr (note that “i” and “j” here are different from the values expressing the number of the antenna described above). Instead of the reception spatial correlation pᵣ, transmission spatial correlation pₜ may be calculated. The transmission spatial correlation pₜ can be calculated by expressions (28) and (29) below.

$$\begin{matrix}{R}_{t} = E [ {H}^{H} H ] & ( 28 ) \\ {ρ}_{t} = \frac{{R}_{t , ij}}{\sqrt{{R}_{t , ii} {R}_{t , jj}}} & ( 29 )\end{matrix}$$

In the following description, the case where the spatial correlation ρ indicates the reception spatial correlation ρᵣ is assumed, but it may indicate the transmission spatial correlation ρₜ. The spatial correlation ρ takes an actual value of a range [0, 1]. As the value of the spatial correlation ρ is smaller, the spatial correlation is little and a code error rate also becomes low. Therefore, from a viewpoint of securing the transmission capacity, it is desirable that the value of the spatial correlation ρ is small. The value of the spatial correlation calculated by the spatial correlation calculator 14 is stored in the spatial correlation storage 15.

The spatial correlation storage 15 can be written by the spatial correlation calculator 14 and can be referred to by the antenna arrangement determiner 17. The spatial correlation storage 15 is configured from one of a nonvolatile storage device such as a NAND flash memory, a NOR flash memory, an MRAM, a ReRAM, a hard disk or an optical disc or a storage device such as a DRAM or a combination thereof.

The spatial correlation calculator 14 and the spatial correlation storage 15 of the transmission station have the configuration similar to that of the spatial correlation calculator 24 and the spatial correlation storage 25 of the reception station, respectively. Note that the channel matrix “H” estimated in the reception station may be fed back to the transmission station and the spatial correlation may be calculated in the spatial correlation calculator 14 of the transmission station. In this case, the information indicating the calculated spatial correlation may be stored in the spatial correlation storage 25.

The antenna arrangement determiner 17 controls other blocks inside the antenna arrangement determination device 1 respectively, and also obtains the arrangement of the antenna 101 and the antenna 102 of the antenna device 100 (the interval between the antennas 101 and 102 and the position of the antenna 101 or 102) suppressing the spatial correlation of the MIMO communication low or guaranteeing the orthogonality. The antenna arrangement determiner 17 includes the candidate value generator 19 that generates candidate values of the antenna interval at the interval according to the installation height of the antenna 101 or 102. The antenna arrangement determiner 17 determines a setting value of the antenna interval based on the communication quality (the spatial correlation or the like) in the case of setting the antenna interval at the respective candidate value, from the candidate values. As an example, the antenna interval at which the spatial correlation is minimum or a threshold or lower is determined. The antenna arrangement determiner 27 also has the configuration similar to that of the antenna arrangement determiner 17. That is, the antenna arrangement determiner 27 controls other blocks inside the antenna arrangement determination device 2 respectively, and also obtains the arrangement of the antenna 201 and the antenna 202 of the antenna device 200 (the interval between the antennas 201 and 202 and the position of the antenna 201 or 202) suppressing the spatial correlation of the MIMO communication low or guaranteeing the orthogonality. The antenna arrangement determiner 27 includes the candidate value generator 29 that generates candidate values of the antenna interval at the interval according to the installation height of the antenna 201 or 202. The operation of the candidate value generator 29 is similar to that of the candidate value generator 19.

In the related technology, the arrangement of the antennas needs to satisfy the requirement of the expression (25) in order to secure the orthogonality of the communication path, and this is a constraint to the antenna installation. In the embodiment of the present invention, it is used that the antenna arrangement capable of suppressing the spatial correlation of a MIMO communication path to be low or securing the orthogonality without satisfying the requirement of the expression (25) is present (details will be described later), and the antenna arrangement that satisfies the constraint of the installation is efficiently obtained. Thus, the antenna device can be installed even at a location where the installation is impossible according to the antenna arrangement calculated based on the requirement of the expression (25). For example, the antenna device can be installed at a position lower than the position demanded by the requirement of the expression (25).

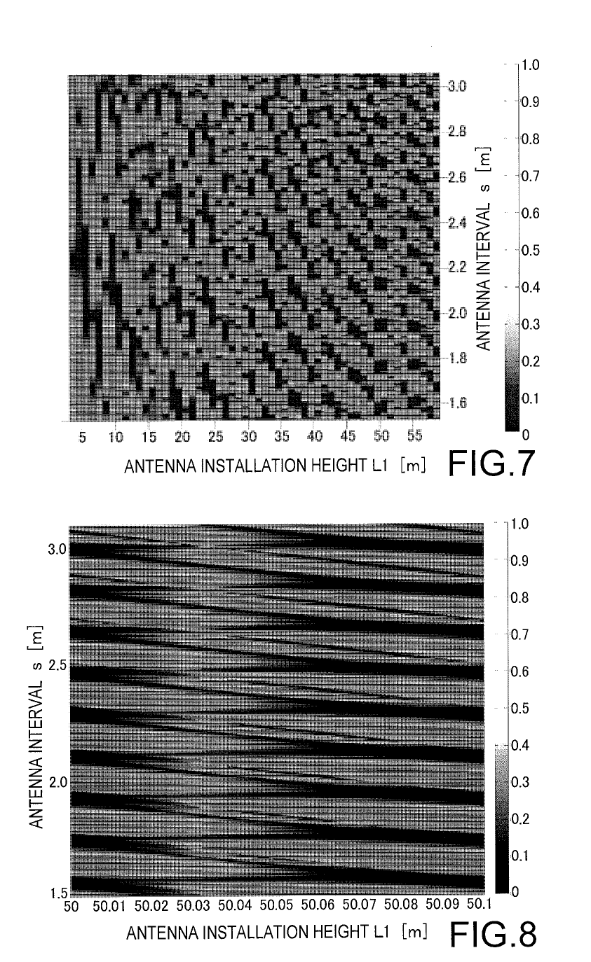

Next, the presence of the antenna arrangement capable of suppressing the spatial correlation of a MIMO communication path to be low or securing the orthogonality without satisfying the requirement of the expression (25) will be described in detail. FIG. 7 illustrates a result of calculating the value of the spatial correlation ρ by performing the simulation for the antenna installation height L1 and the antenna interval “s” of a fixed range, using a radio wave propagation model of two waves including the direct wave and the ground reflected wave. It is defined that the transmission/reception distance “D” is 5000 m, and the frequency “f” is 80×10⁹ Hz. For the range of the antenna installation height L1 and the antenna interval “s”, the range of the antenna installation height L1 is roughly 3 m to 59 m, and the range of the antenna interval “s” is roughly 1.575 m to 3.25 m. FIG. 8 magnifies and displays part of a distribution in FIG. 7, the range of the antenna installation height L1 is roughly 50 m to 50.1 m, and the range of the antenna interval “s” is roughly 1.5 m to 3.25 m. As the spatial correlation is lower, a color becomes darker.

As described in FIG. 4 above, the position of the antenna installation height L1 satisfying the expression (25) is discrete, and one antenna interval corresponding to it is determined. As recognized from the spatial correlation simulation results in FIG. 7 and FIG. 8, there are many combinations of the antenna installation height L1 and the antenna interval “s” with the low spatial correlation (near 0.1, for example). In this way, even when the antenna arrangement does not satisfy the condition of the expression (25), there are many combinations of the antenna installation height L1 and the antenna interval “s” capable of suppressing the spatial correlation to be low.

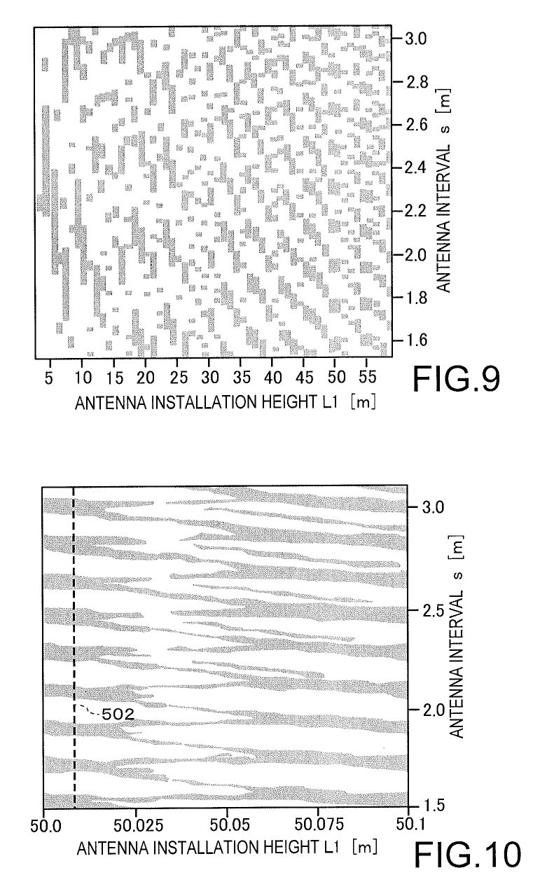

As an example, an extracted illustration of the distribution of a range 501 where the spatial correlation ρ is 0.1 or smaller in the simulation result in FIG. 7 and FIG. 8 is respectively schematically illustrated in FIG. 9 and FIG. 10. Here, the range where the spatial correlation ρ is 0.1 or smaller is a target, but it is just an example, and a value larger than 0.1 may be defined as a reference and a range smaller than that may be turned to the target, or a value smaller than 0.1 may be defined as a reference and the range smaller than that may be turned to the target. From FIG. 9 and FIG. 10, it is recognized that, when the value of the antenna installation height L1 is fixed and the value of the antenna interval “s” is changed, the range where the spatial correlation ρ becomes 0.1 or lower is repeated at every roughly fixed interval. For example, when focusing on the antenna installation height L1 illustrated by a broken line 502 in FIG. 10, the tendency can be confirmed. Hereinafter, the tendency is referred to as “periodicity of a low spatial correlation part”. Further, when FIG. 7 is checked, it is recognized that, as the antenna installation height L1 becomes larger, the cycle of the low spatial correlation part (an appearance interval of the low spatial correlation part) tends to become short.

The antenna arrangement determiner 17 generates a plurality of candidate values s_{c} of the antenna interval under the condition set in the environmental value setter 13. The set condition here includes, as an example, the transmission/reception distance “D”, the wavelength λ or the frequency “f”, and the range [Nₗ, Nₕ] of the antenna installation height L2. The range [Lₗ, Lₕ] of the antenna installation height L1 may also be included.

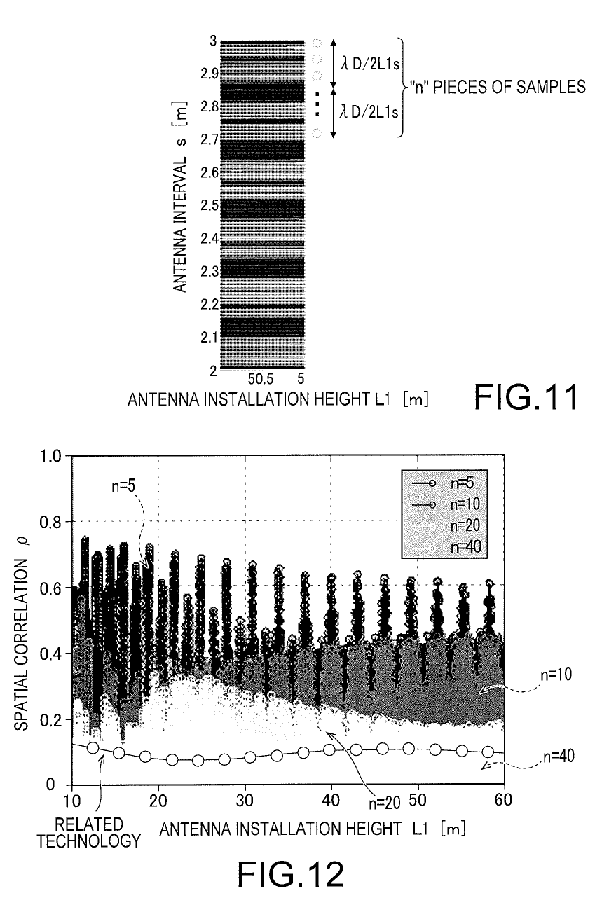

An example of a method of generating the candidate value s_{c} of the antenna interval will be described using FIG. 11. Here, the case where the antenna installation height is a certain value L1ₛ (50.5 in the figure) is assumed.

In this example, √(λD/2) is defined as an initial candidate value (initial value), and the candidate value of the antenna interval is generated (sampled) at the interval according to the installation height L1ₛ in a reducing direction of the antenna interval “s”. The initial value may be any, and √(λD/2) is an example. By turning the initial value to an upper limit value, the antenna interval to be set can be searched such that the installation height L2 of the antenna 102 does not become larger than L1+the initial value. In addition, as described above, even in the case that the antenna interval is √(λD/2), the spatial correlation does not become 0, and the antenna interval capable of obtaining the spatial correlation better than that may be present. The initial value may be determined according to a desired installation height of the antenna device. The initial value may be specified from the outside, or may be preset.

A double circle in the figure schematically illustrates a sampled part. In this example, a section of a length for two of λD/2L1ₛ is a search range (candidate range), and “n” pieces of the candidate values (samples) are selected at the fixed interval from the search range. As described above, as the antenna installation height L1 (or L2) becomes larger, the cycle (appearance interval) of the low spatial correlation part in the direction of the antenna interval “s” tends to become short. Then, L1ₛ is included in a denominator such that the search range becomes small as the antenna installation height L1 (or L2) becomes larger according to the tendency. Thus, an efficient search according to the antenna installation height L1 (or L2) becomes possible. That is, when the size of the search is too narrow, a possibility that a part where the value of spatial correlation ρ is the smallest is omitted from selection targets becomes high, and when the size of the search range is too large, a computational load becomes large. Then, by reducing the search range as the installation height L1 is larger according to the tendency above, while preventing such problems, an efficient search is performed. Note that an n value is arbitrary as long as it is a positive integer value. For example, it is 5, 10, 20 or the like. As the value of “n” is larger, the interval of the samples becomes short. Since the search range becomes small when the installation height is large, the interval of the samples is reduced as the installation height is larger. The plurality of values of “n” may be prepared and the processing may be performed with the plurality of values of “n” as targets.

A size of the search range may be a range of A/L1ₛ or the multiple (“A” is an arbitrary real number), or may be determined by another method such as using power of L1ₛ for the denominator. The search range may be a fixed size or determined by another arbitrary method, and the interval of the samples may be reduced as the installation height is larger.

In the method illustrated in FIG. 11, the candidate value s_{c} of the antenna interval is generated within the range of s_{c}≤√(λλD/2) so that the height of the antennas 102 and 202 is settled in the range of Lₛ+√(λD/2) or lower and does not become higher than that. However, in the case that the height L1 of the antennas 102 and 202 can be higher than L+q(λD/2), the value larger than √(λD/2) may be taken as the candidate value s_{c} of the antenna interval.

For a plurality of Lₛ of the range [Lₗ, Lₕ] of the antenna installation height L1, similarly, the antenna interval s_{c} may be selected (sampled). However, in the case where the antenna installation height L1 is determined beforehand or the like, the antenna interval s_{c} may be sampled with only the antenna installation height of the value as the target.

The candidate value s_{c} of the antenna interval is delivered to the antenna position adjuster 11 and the transmission/reception adjustment synchronizer 12, and the size of the antenna interval of the antenna devices 100 and 200 is adjusted to be the candidate value s_{c}. At the adjusted antenna interval s_{c}, the pilot signals are transmitted from the transmission station, the estimation of the channel matrix and the calculation of the spatial correlation are performed in the reception station, and storage in the spatial correlation storage 15 is performed. Note that the spatial correlation can be performed also by the simulation using the radio wave propagation model, and in that case, it is not needed to actually perform the adjustment of the antenna interval and the transmission of the pilot signals or the like in the antenna devices 100 and 200. The antenna arrangement determiner 17 determines the antenna interval candidate value s_{c} of the lowest spatial correlation or a threshold or lower among the plurality of antenna interval candidate values s_{c} and the antenna installation height L1. The determined candidate value s_{c} and the installation height L are defined as the setting value of the antenna installation height L1 and the setting value “s” of the antenna interval. When the antenna installation height L1 is determined as a specific value, the antenna interval candidate s_{c} of the lowest spatial correlation or the threshold or smaller is defined as the setting value “s”.

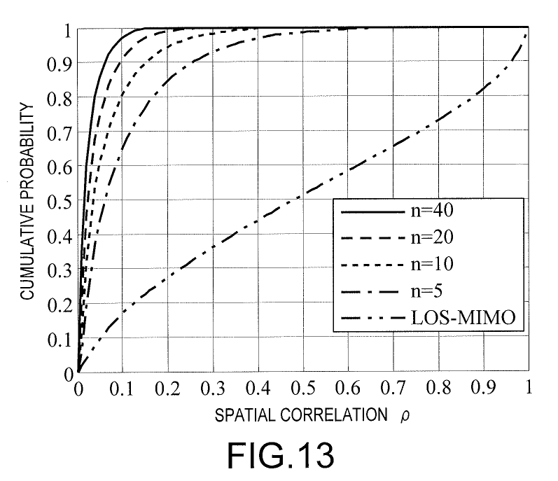

FIG. 12 is a graph in which values of the minimum spatial correlation ρ obtained for the respective values of the antenna installation height L1 are plotted by circles in the case where the simulation is repeatedly performed and “n” is defined as n=5, n=10, n=20 and n=40. Note that, as the value of “n” is larger, the graph is displayed on a front side. Therefore, attention is paid to the fact that, of the graph of n=5 for example, parts overlapping with the graphs of n=10, n=20 and n=40 are hidden behind and are invisible. FIG. 13 illustrates a cumulative probability distribution of a spatial correlation value to the respective values of “n” in FIG. 12, and the cumulative probability distribution (graph of LOS-MIMO) of the related technology.

When the result is checked, it is recognized that, as the value of “n” is made larger, the low spatial correlation ρ is easily extracted for the respective values of the antenna installation height L1. In the case of n=40, since the sampling interval is small, the low spatial correlation ρ can be extracted at many antenna installation heights, but in the case of n=5 or n=10, since the sampling interval becomes wide, the extracted spatial correlation ρ often becomes high.

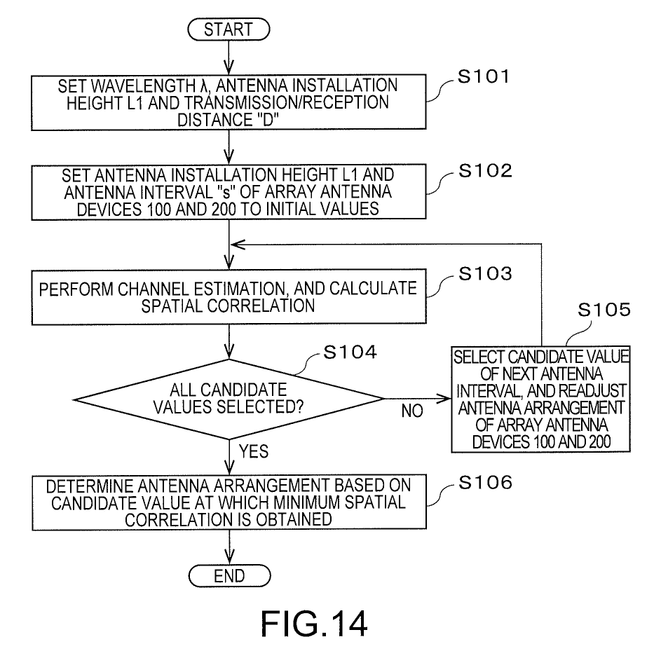

FIG. 14 is a flowchart illustrating the processing according to the first embodiment.

In step S101, the parameters such as the wavelength 2, the antenna installation height L1 (or the range of the antenna installation height L2) and the transmission/reception distance “D” are set to the respective antenna arrangement determination devices of the transmission station and the reception station. Instead of the wavelength k, the frequency “f” may be set. By notifying the parameter set to one communication station to the other communication station, the same parameter may be set to both stations.

In step S102, the antenna installation height L1 and the antenna interval “s” of the antenna devices 100 and 200 are set to the initial values. The initial value of the antenna interval “s” is arbitrary, but is defined as √(λD/2) as an example. As a specific operation, the antenna arrangement determiner 27 on the side of the reception station 2 acquires the wavelength 2, the antenna installation height L1 and the transmission/reception distance “D” which are the parameters from the environmental value setter 23, and calculates the initial value (candidate value) √(λD/2) of the antenna interval. In the case where the antenna installation height L1 is not an adjustment target, the value of the antenna installation height L1 set in step S101 is set as the initial value. In the case where the antenna installation height L1 is also the adjustment target, within the range of the antenna installation height L1, the candidate values of the installation height L1 are selected in an arbitrary order, and for the respective selected candidate values, the following processing of step S103 and subsequent steps is repeatedly executed. The specific processing executed in step S102 will be described below.

The antenna arrangement determiner 27 delivers the initial value of the antenna interval and the value of the antenna installation height L1 to the antenna position adjuster 21 and the transmission/reception adjustment synchronizer 22. The antenna position adjuster 21 adjusts the positions of the antennas 201 and 202 according to the antenna device 200 based on the values. The transmission/reception adjustment synchronizer 22 transmits the information indicating the initial value of the antenna interval and the antenna installation height to the transmission/reception adjustment synchronizer 12 on the transmission station side. The transmission/reception adjustment synchronizer 12 delivers the initial value of the antenna interval and the value of the antenna installation height to the antenna position adjuster 11. The antenna position adjuster 11 adjusts the positions of the antennas 101 and 102 according to the antenna device 100 based on the values. While the parameters are provided from the reception station to the transmission station here, the parameters may be provided from the transmission station to the reception station.

In step S103, the antenna arrangement is adjusted to the initial value of the antenna interval “s” and the initial value of the antenna installation height L1, the channel estimation is performed, and the spatial correlation is calculated. The specific processing executed in step S103 will be described below.

First, for the channel estimation, as described in the description of the operation of the channel estimator 26, as an example, the reception station transmits instruction signals instructing the transmission of the pilot signals to the transmission station, and the transmission station transmits the pilot signals according to the instruction signals. The channel estimator 26 of the reception station receives the pilot signals through the respective antennas, performs the channel estimation, and obtains the channel matrix “H”. Subsequently, the spatial correlation calculator 24 calculates the spatial correlation (the reception spatial correlation ρᵣ or the transmission spatial correlation ρₜ), and preserves the calculated spatial correlation in the spatial correlation storage 25 together with the current candidate value of the antenna interval (the current value of the antenna installation height, too, in the case where the antenna installation height is also the adjustment target). As an example, preservation is performed in a form of a spatial correlation table in which the spatial correlation and the candidate value are made to correspond, or in a form of a spatial correlation table in which the spatial correlation, the candidate value and the installation height L1 are made to correspond.

In the next step S104, whether or not the spatial correlation is calculated for all the candidate values of the antenna interval is determined, the processing advances to step S105 when the candidate value for which the spatial correlation is not calculated yet is present, and the processing advances to step S106 when the spatial correlation is calculated for all the candidate values.

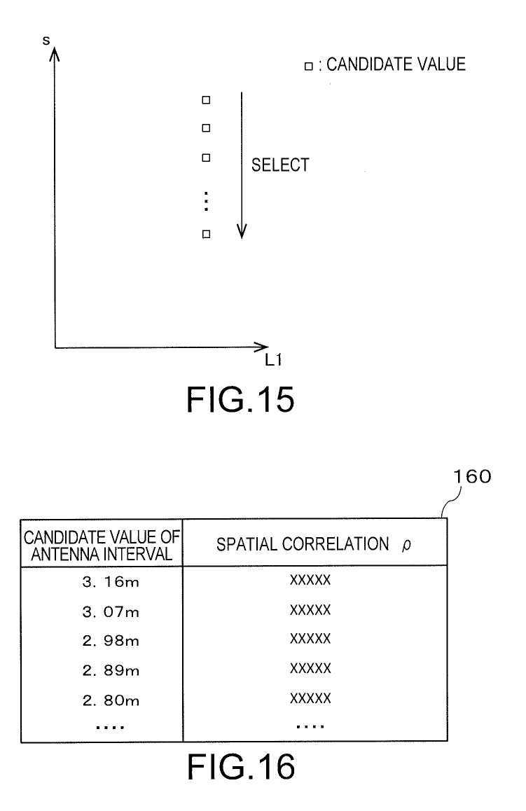

In step S105, the next candidate value of the antenna interval is selected, and the antenna positions of the antenna devices 100 and 200 are readjusted. By fixing the antenna installation height L1 and moving the antenna on an upper side, the antenna interval is adjusted (as a result, the antenna installation height L2 is adjusted). For the next candidate value of the antenna interval, as described above, as the antenna installation height L1 is larger, the sample interval (the interval of the candidate value) becomes small. An example of a spatial correlation table 160 storing the spatial correlation for all the candidate values for a certain specific antenna installation height L1 is illustrated in FIG. 16. In this example, the case where the initial value of the antenna interval is 3.16 m and the sample interval is 0.09 m is illustrated. The value of the spatial correlation is schematically expressed by a sign “XXXXX”, but actually, a value is entered. In this example, “n” pieces of samples are arranged as the candidate values at equal intervals within a length of two of λD/2L1, and the candidate value is successively selected from an origin (upper limit value) which is the initial value. A situation of successively selecting the candidate value is schematically illustrated in FIG. 15. A rectangle at the top of the figure expresses the initial candidate value. Every time of taking step S105, the candidate value is selected in a direction of reducing “s”.

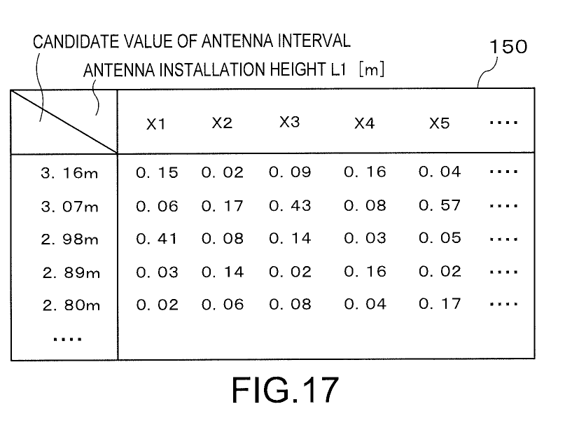

In step S106, the antenna arrangement determiner 27 specifies the candidate value at which the minimum spatial correlation is obtained from the spatial correlation storage 25, and determines the specified candidate value as the setting value of the antenna interval. The specified candidate value may be compared with the threshold, and in the case of being the threshold or larger, the sample number “n” may be increased stepwise until the spatial correlation smaller than the threshold is obtained so as to perform a finer search. In the case where the antenna interval at which the spatial correlation becomes smaller than the threshold cannot be detected even when “n” is increased to a certain value, the antenna installation height L1 may be set to a different value and the antenna interval may be searched again. Thereafter, the change of the value of “n” and the change of the antenna installation height may be repeated until the spatial correlation smaller than the threshold is obtained. The value of “n” may be fixed and only the value of the antenna installation height L1 may be changed. An example of a spatial correlation table 150 obtained in the case of performing the processing to step S106 for the plurality of values of the antenna installation height L1 is illustrated in FIG. 17. Differently from FIG. 16, an item of the antenna installation height L1 is added. The values of the antenna installation height L1 are expressed by signs as X1, X2 . . . , but actually, values are entered. In addition to the change of the antenna installation height L1, in the case of changing the value of “n”, the table like FIG. 17 is obtained for each value of “n”. The table may be provided to a user through an interface, and the user may determine the setting value of the antenna installation height L1 and the setting value of the antenna interval.

The antenna arrangement determiner 27 notifies the setting value of the antenna interval and the setting value of the antenna installation height L1 that are determined to the transmission station. Thus, the antenna arrangement is established in both of the reception station and the transmission station. Thereafter, the antenna position adjuster 21 of the reception station adjusts the positions of the antennas 201 and 202 based on the setting value, and the antenna position adjuster of the transmission station also adjusts the positions of the antennas 101 and 102. After the adjustment, the MIMO communication is performed between the transmission station and the reception station. Or, the user may determine the antenna installation height L1 and the antenna interval of the antenna device to be installed in a building or the like based on the spatial correlation table or a spatial correlation map, and may design the antenna device based on determined contents.

As a modification of the flowchart in FIG. 14, the spatial correlation calculated in step S103 may be compared with the threshold, and when it is smaller than the threshold, the candidate value of the antenna interval when the spatial correlation is obtained may be determined as the setting value of the antenna interval. Thus, since search processing for the other candidate values can be omitted, computing time can be shortened.

In the present embodiment, the channel estimation is performed by actual measurement, but it can also be performed by simulation. For example, in the case where the two waves of the direct wave and the ground reflected wave are dominant channels, the channel response (channel information) may be calculated using the Friis transmission formula from the installation height of each antenna on the transmission station side, the installation height of each antenna on the reception station side, and the transmission/reception distance. Or, the channel response may be calculated using a simulator simulating the channel between transmission and reception. In the simulation, when surrounding geographical information such as topography between the transmission and reception stations, use situations of land and existing structures is considered and modeling with high reproducibility of an actual environment is performed, reliability of the spatial correlation map or the spatial correlation table also becomes high.

In addition, in the present embodiment, the plurality of candidate values are set at the interval according to the antenna installation height L1, and the candidate value at which the minimum spatial correlation or the spatial correlation of the threshold or smaller is determined as the setting value of the antenna interval. As another method, a steepest descent method may be applied to the data within a search range to find the antenna interval at which the spatial correlation is minimum or the threshold or smaller. By using the periodicity of the low spatial correlation part within the search range described above, a set of the minimum spatial correlation value and the antenna interval can be found by the steepest descent method.

In addition, in the present embodiment, the case of fixing the positions of the antennas 101 and 201 on the lower side and moving the antennas 102 and 202 on the upper side is illustrated, but the antenna interval may be adjusted by fixing the positions of the antennas on the upper side and moving the antennas on the lower side. In this case, the antenna interval capable of obtaining the high communication quality can be efficiently found without changing the installation height of the antennas on the upper side.

As described above, according to the present embodiment, the antenna interval capable of obtaining the high communication quality can be determined such that the installation height of the antennas 102 and 202 on the upper side is settled in the desired range.

### Second Embodiment

The second embodiment is characterized by calculating a transmission rate instead of the channel estimation and the spatial correlation calculation performed in the first embodiment, and determining the antenna interval at which the calculated transmission rate is highest or higher than or equal to the threshold. The transmission rate can be used instead of the spatial correlation because it can be presumed that, when the high transmission rate is obtained, occurrence of channel interference is suppressed and low correlation of the MIMO communication path is secured. Instead of the transmission rate, an index indicating a different communication performance such as a bit error rate may be used. The spatial correlation and the index (the transmission rate, the bit error rate or the like) indicating the communication performance are examples of the index indicating the communication quality between the transmission station and the reception station. Hereinafter, the second embodiment will be described with the case of the transmission rate as an example.

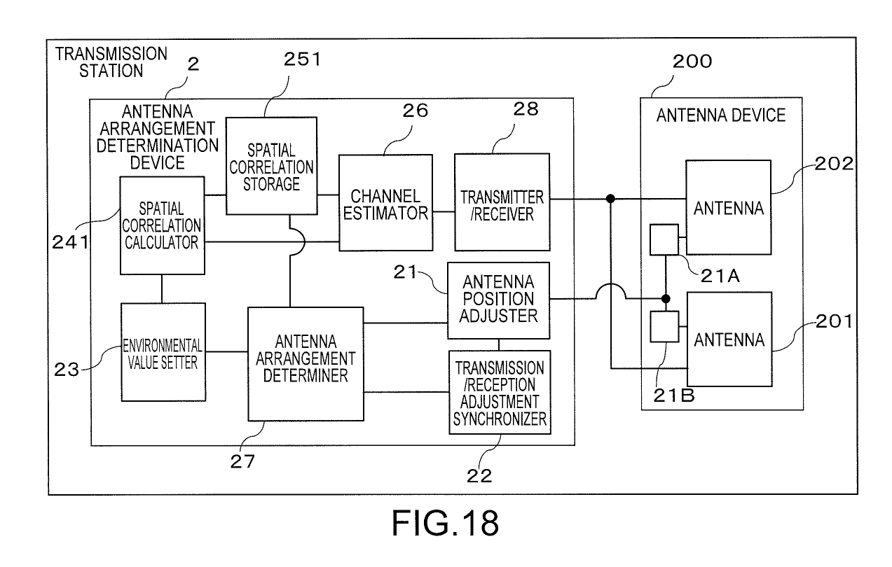

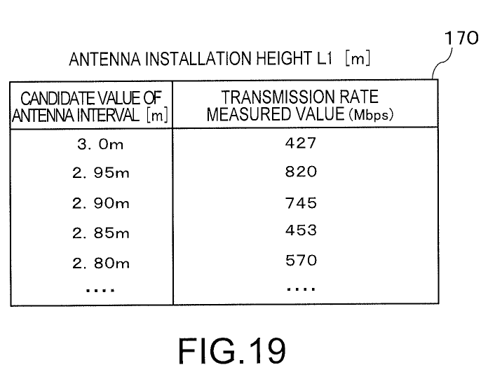

FIG. 18 illustrates a block diagram of the antenna arrangement determination device of the reception station according to the second embodiment. The spatial correlation calculator 24 and the spatial correlation storage 25 in FIG. 6 are changed to a transmission rate calculator 241 and a transmission rate storage 251. Similarly in the transmission station, the spatial correlation calculator 14 and the spatial correlation storage 15 may be replaced by a transmission rate calculator and a transmission rate storage (not illustrated). The transmission rate calculator 241 measures the transmission rate between the transmission station and the reception station for each of the plurality of candidate values of the antenna interval. The transmission rate storage 251 stores therein the candidate value and a measured value of the transmission rate in a correspondence manner. As in FIG. 19, a transmission rate table 170 in which the candidate value of the antenna interval and the measured value of the transmission rate are made to correspond may be generated. In the case where the antenna installation height is the adjustment target, similarly to the spatial correlation table in FIG. 17, the item of the antenna installation height may be added.

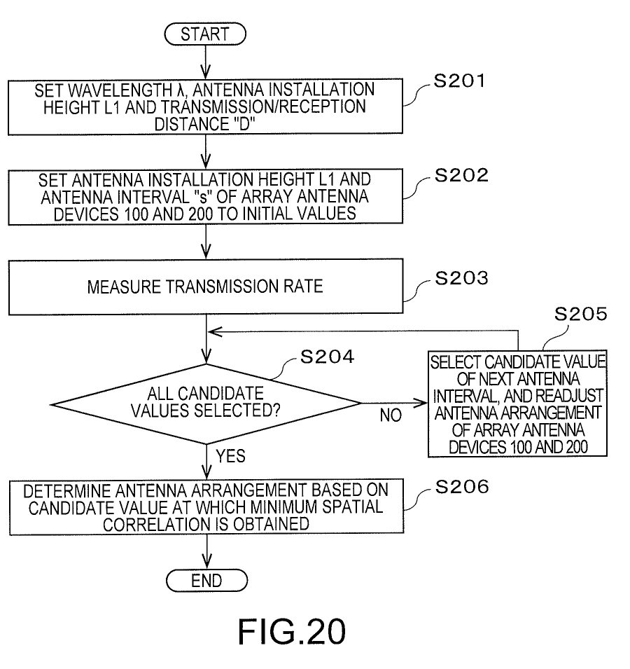

FIG. 20 is a flowchart illustrating the processing according to the second embodiment. Step S201 and step S202 are the same as step S101 and step S102 in the first embodiment. In step S203, the transmission rate from the transmission station to the reception station is measured. For the measurement of the transmission rate, for example, the transmission rate may be measured for a plurality of times and the average, maximum or minimum transmission rate may be determined.

Step S204 and step S205 are the same as steps S104 and S105 in the first embodiment. In step S206, the candidate value at which the maximum transmission rate is obtained is specified, and the specified candidate value is determined as the setting value of the antenna interval. The specified candidate value may be compared with the threshold, and in the case of being smaller than the threshold, the sample number “n” may be increased stepwise until the transmission rate of the threshold or higher is obtained so as to perform a finer search. In the case where the antenna interval at which the transmission rate becomes the threshold or higher cannot be detected even when “n” is increased to a certain value, the antenna installation height L1 may be set to a value larger or a value smaller than a current value and the antenna interval may be searched again. Thereafter, the change of the value of “n” and the change of the antenna installation height may be repeated until the transmission rate of the threshold or higher is obtained. The value of “n” may be fixed and only the value of the antenna installation height may be changed. Or, a section to generate the plurality of candidate values may be changed. For example, in the case where the generation section of the candidate values is 3.16 to 2.80 first, it may be shifted by 0.13 and turned to 3.03 to 2.67 or the like.

The transmission rate is described as an example in the present embodiment, but execution can be similarly performed also in the case of using a different index regarding the communication performance such as the bit error rate.

### Third Embodiment

In the third embodiment, the antennas relating to the antenna devices on both of the transmission side and the reception side are arranged not in the vertical direction but in an oblique or horizontal direction to the ground.

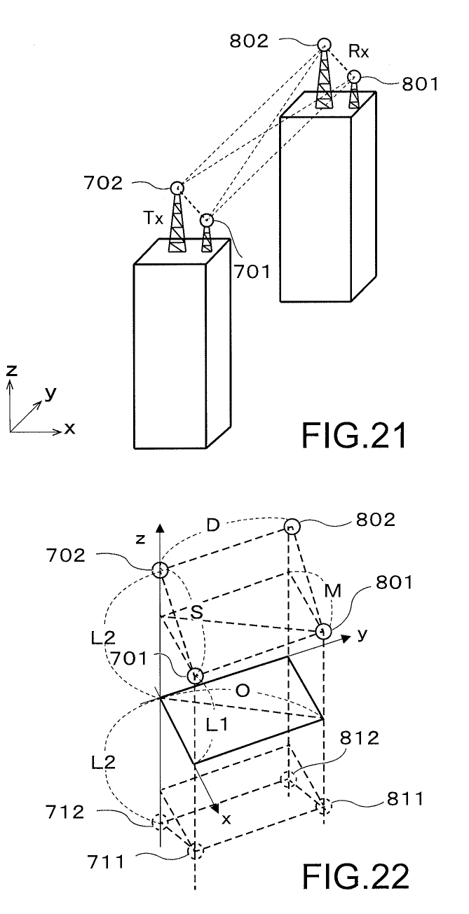

FIG. 21 is a schematic perspective view of the transmission station and the reception station according to the third embodiment. An antenna 701 and an antenna 702 on the transmission side and an antenna 801 and an antenna 802 on the reception side are arranged on structures such as buildings. Note that the height of the antenna 701 is the same as the height of the antenna 801, and the height of the antenna 702 is the same as the height of the antenna 802. In addition, a relative positional relation of the antenna 701 and the antenna 702 and a relative positional relation of the antenna 801 and the antenna 802 are the same.

FIG. 22 is a diagram for describing the communication path of the reflected waves according to the present embodiment. A mirror image 711 indicates a mirror image of the antenna 701 to the ground, a mirror image 712 indicates a mirror image of the antenna 702 to the ground, a mirror image 811 indicates a mirror image of the antenna 801 to the ground, and a mirror image 812 indicates a mirror image of the antenna 802 to the ground, respectively.

When left sides and right sides of the expression (6) and the expression (7) are added to each other and the left side and the right side of the expression (5) are subtracted, an expression of the orthogonality condition of the ground reflected waves below is obtained.

$$( {d}_{11 r} - {d}_{12 r} ) + ( {d}_{22 r} - {d}_{21 r} ) = \frac{λ}{2} ( 2 {p}_{1} - 2 {p}_{2} - 2 {p}_{3} - 1 ) \qquad ( 30 )$$

Using FIG. 22, the communication path relating to the ground reflected waves included in the expression (30) will be described. The sign d₁₁ᵣ indicates a route of the ground reflected waves between the antenna 701 and the antenna 801.

A length of d₁₁ᵣ is equal to the length of a straight line connecting the antenna 701 and the mirror image 811 or the length of a straight line connecting the antenna 801 and the mirror image 711. Therefore, d₁₁ᵣ can be expressed as in the following expression (31).

d₁₁ᵣ=\sqrt{D²+(2·L1)²} (31)

The sign d₂₂ᵣ indicates a route of the ground reflected waves between the antenna 702 and the antenna 802. The length of d₂₂ᵣ is equal to the length of a straight line connecting the antenna 702 and the mirror image 812 or the length of a straight line connecting the antenna 802 and the mirror image 712. Therefore, d₂₂ᵣ can be expressed as in the following expression (32).

d₂₂ᵣ=D²+(2·L2)² (32)

The sign d₁₂ᵣ indicates a route of the ground reflected waves between the antenna 802 and the antenna 701. The sign d₂₁ᵣ indicates a route of the ground reflected waves between the antenna 801 and the antenna 702. The lengths of d₁₂ᵣ and d₂₁ᵣ are equal. The lengths of d₁₂ᵣ and d₂₁ᵣ are equal to the length of a straight line connecting the antenna 701 and the mirror image 812 or the length of a straight line connecting the antenna 802 and the mirror image 711. In addition, the length of a line segment “M” in FIG. 22 is expressed as follows.

M=\sqrt{s²−(L2−L1)²}=\sqrt{s²−L22+2·L2·L1−L1²} (33)

Using the expression (33), the length of a line segment “O” in FIG. 22 is expressed as follows.

O=\sqrt{M²+D²}=\sqrt{s²−L2²+2·L2·L1−L1²+D²} (34)

Therefore, the lengths of d₁₂ᵣ and d₂₁ᵣ are expressed as follows.

d₁₂ᵣ=d₂₁ᵣ=\sqrt{O²+(L1+L2)²}=\sqrt{D²+s²+4·L2·L1} (35)

When the expressions (31), (32) and (35) are substituted in the expression (30), the following expression is obtained.

$$L 2 - L 1 = \pm \sqrt{\frac{λ D ( 2 {p}_{1} - 2 {p}_{2} - 2 {p}_{3} - 1 ) + 2 {s}^{2}}{4}} \qquad ( 36 )$$

When it is p₁=0, p₂=−1 and p₃=0 in the expression (36), the following expression (37) is obtained.

$$L 2 - L 1 = \pm \sqrt{\frac{λ D + 2 {s}^{2}}{4}} \qquad ( 37 )$$

When the antennas are arranged in the oblique direction so as to satisfy the relation of the expression (37), the orthogonality of the communication path or the low spatial correlation can be secured similarly to the vertically arranged antenna devices according to the first embodiment and the second embodiment. Similarly to the description using FIG. 7 and FIG. 8 in the first embodiment, other than the antenna interval “s” satisfying the expression (37), there are many antenna intervals and antenna installation positions at which the low spatial correlation can be obtained. As the antenna installation height is larger, the cycle of the antenna interval at which the low spatial correlation can be obtained becomes small. Thus, by performing antenna position adjustment processing (see the flowchart in FIG. 14) similarly to the first embodiment, the antenna interval and the antenna installation position at which the low spatial correlation can be obtained can be determined. When performing the position adjustment processing, the initial value of the antenna interval may be the antenna interval “s” satisfying the expression (37) as an example.

Further, when it is p₁=0, p₂=0 and p₃=0 in the expression (36), the following expression (38) is obtained.

$$L 2 - L 1 = \pm \sqrt{\frac{- λ D + 2 {s}^{2}}{4}} \qquad ( 38 )$$

When the antenna interval is adjusted so that λR and 2s² become equal, the right side of the expression (38) becomes 0. In such a case, L2=L1 is established, and the heights of the antennas 701, 702, 801 and 802 all become equal. That is, the antennas 701 and 702 are horizontally arranged, and the antennas 801 and 802 are also horizontally arranged. Also in this case, flexible antenna arrangement that realizes the low spatial correlation can be performed by the antenna position adjustment processing. In this way, the embodiment of the present invention can be applied regardless of an arrangement direction of the antennas such as the vertical arrangement, the arrangement in the oblique direction and the arrangement in the horizontal direction.

### Fourth Embodiment

The fourth embodiment is characterized by performing the antenna position adjustment processing by a frequency (or a wavelength) at which influence of frequency selective fading is reduced within a frequency band to be used.

When the frequency selective fading occurs within the frequency band used by the wireless communication device, the communication quality is affected.

Therefore, by using the frequency with relatively less influence of frequency fading, the antenna position adjustment processing can be effectively performed.

In the processing according to the fourth embodiment, in step S101 in FIG. 14 or step S201 in FIG. 20, the frequency or the wavelength 2 with less influence of the frequency selective fading is selected.

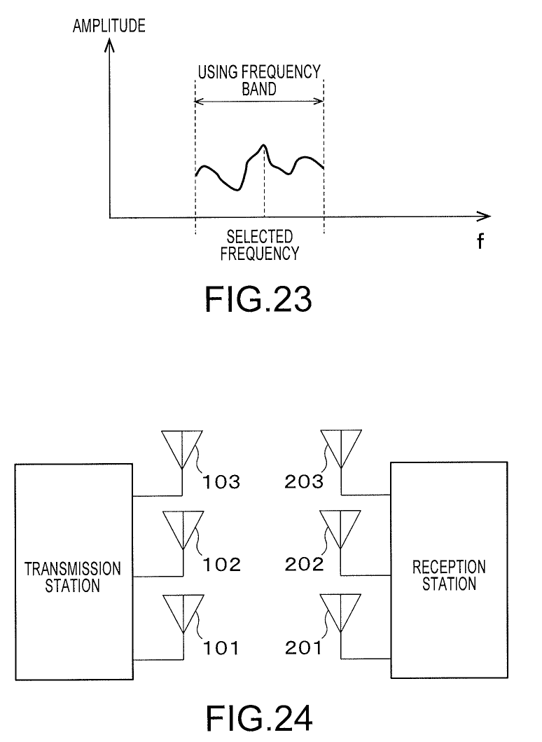

For example, signals for testing are transmitted from the transmission station to the reception station in the using frequency band, and reception signals are analyzed. Thus, as illustrated in FIG. 23, data indicating an amplitude for each frequency is acquired. Based on the data, the frequency (or the wavelength) at which signal strength is highest or is the threshold or higher is selected. The signals may be transmitted for a plurality of times, and the frequency at which time fluctuation of the signal strength is little and a time average value of the signal strength is the threshold or larger may be selected. The selected frequency is used to perform the communication for the position adjustment (the communication for the channel estimation or the like). In the communication, a narrow band with the selected frequency at a center is used. In normal communication after the position adjustment, the entire frequency band including the selected frequency may be used.

By the present embodiment, the antenna positions can be more effectively adjusted.

### Fifth Embodiment

In the fifth embodiment, in the configuration that there are three or more antennas respectively in the antenna devices on the transmission side and on the reception side, two antennas are selected in each of the antenna devices on the transmission side and on the reception side, and the antenna position adjustment processing in the embodiments described so far is performed with the selected two antennas as targets.

FIG. 24 schematically illustrates the transmission station including three antennas 101, 102 and 103, and the reception station including three antennas 201, 202 and 203. The antennas of the transmission station are arranged vertical to the ground in the order of the antennas 101, 102 and 103 from the side close to the ground. The antennas of the reception station are arranged vertically to the ground in the order of the antennas 201, 202 and 203 from the side close to the ground. As an example, the antennas 101 and 201 are arranged at the same height, the antennas 102 and 202 are arranged at the same height, and the antennas 103 and 203 are arranged at the same height.

When selecting two antennas to perform the position adjustment, as an example, the antennas in the same relative positional relation in both of the transmission station and the reception station are selected. For example, the antennas 102 and 103 are selected from the transmission station, and the antennas 202 and 203 are selected from the reception station.

Or, the antennas 101 and 103 may be selected from the transmission station, and the antennas 201 and 203 may be selected from the reception station. The antennas of the other combination may also be selected.

After the positions are adjusted, 3×3 MIMO communication may be performed using the three antennas respectively in the transmission station and the reception station.

While the case of the three antennas respectively in the transmission station and the reception station is illustrated in FIG. 24, the antenna selection and the position adjustment may be performed similarly also in the case of including four or more antennas.

### Sixth Embodiment

In the sixth embodiment, the case of performing bidirectional MIMO communication using FDD (Frequency Division Duplex) between the transmission station and the reception station is assumed. The FDD realizes full duplex communication by allocating difference frequencies respectively for the transmission and for the reception. Specifically, the communication is simultaneously performed using different frequency bands for the transmission from the transmission station to the reception station and the transmission from the reception station to the transmission station (the reception from the reception station by the transmission station) (the frequency bands to be used do not overlap). Note that a guard band is provided between the frequency band for the transmission and the frequency band for the reception.

In the sixth embodiment, in the FDD, the antenna interval and the antenna installation height L1 or L2 capable of suppressing the spatial correlation in common to both of the transmission and the reception are determined. As a specific operation example, for the transmission from the transmission station to the reception station, similarly to the first embodiment, the spatial correlation table (see FIG. 16 and FIG. 17) is prepared. Similarly, the spatial correlation table is generated similarly for the transmission from the reception station to the transmission station. The spatial correlation table may be prepared for each installation height within the range of the antenna installation height, or may be prepared only for a specific antenna installation height. In both of the spatial correlation tables, the antenna interval and the antenna installation height L1 (or a set of the antenna interval and the antenna installation height L2) at which the spatial correlation is minimum or is smaller than the threshold are specified. The values of the specified antenna interval and antenna installation height L1 (or L2) are determined as the setting values.

### Seventh Embodiment

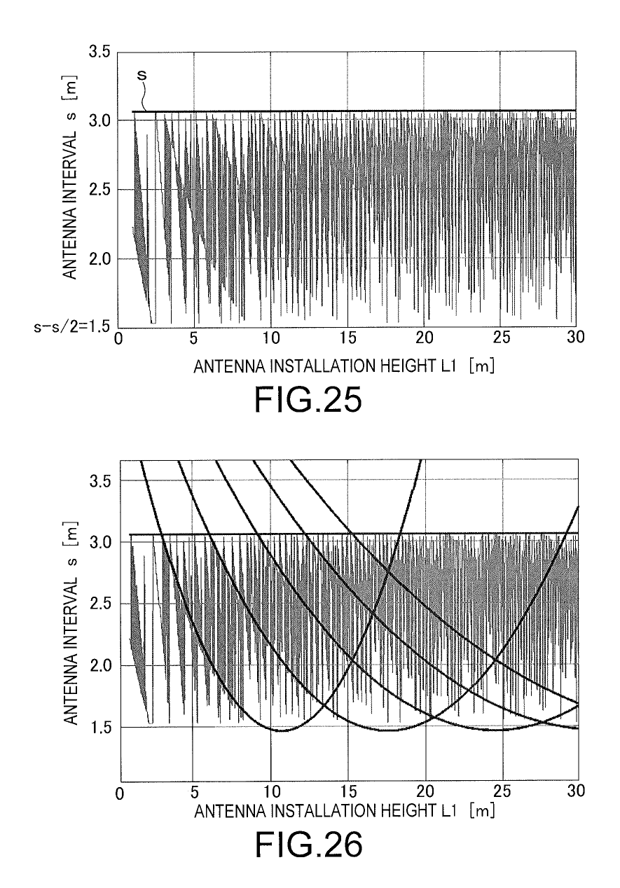

In FIG. 25, the antenna interval is changed from s−s/2 to “s” for the plurality of values of the antenna installation height L1 by simulation, and the antenna intervals at which the spatial correlation becomes minimum among them are plotted and connected in a graph. The value of “s” is determined by an arbitrary method. As an example, it is s=√(λD/2), similarly to the first embodiment. The distribution is concentrated to s−s/2 or larger. From this fact, the range of setting the candidate value of the antenna interval (the search range of the candidate value) may be s−s/2 to “s”. In the case of applying the same model as the simulation, the result of the simulation may be stored and one antenna interval corresponding to the antenna installation height L1 to be applied may be specified from the simulation result. The simulation result may be in a graph form as in FIG. 25, or may be in the form of the spatial correlation table in the first embodiment. In this case, the candidate value of the antenna interval may not be searched as in the first embodiment.

An approximation graph in which the spatial correlation becomes minimum in FIG. 25 may be calculated, and the approximation graph may be stored instead of storing the simulation result in FIG. 25. In the case of applying the same model as the simulation, the antenna interval corresponding to the antenna installation height L1 to be applied may be specified from the approximation graph. In this case, it is not needed to search the candidate value of the antenna interval as in the first embodiment. As a calculation example of the approximation graph, in

ks<h₂<(k+1)s (39)

a quadratic function passing through three points of (ks, s), ((3k+1)/2s, ⅔s), ((2k+1)s, ½k) may be derived.

Elements on the left side inside parentheses indicate the installation height, and elements on the right side indicate the antenna interval. FIG. 26 illustrates an example of the plurality of quadrative functions obtained with k=1, 2, . . . .

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An antenna arrangement determination device comprising:
a candidate value generator configured to generate candidate values of a distance between a plurality of antennas, at an interval according to an installation height of an arbitrary one of the antennas, the distance between the antennas being adjustable;
a calculator configured to calculate communication quality in a case of setting the distance between the antennas at the candidate values; and
an antenna arrangement determiner configured to determine a setting value of the distance between the antennas from the candidate values based on the communication quality.

2. The antenna arrangement determination device according to claim 1,
wherein the interval of the plurality of candidate values is smaller as the installation height is larger.

3. The antenna arrangement determination device according to claim 1,
wherein the candidate value generator generates the candidate values within a range of a size according to the installation height.

4. The antenna arrangement determination device according to claim 3,
wherein the size of the range is smaller as the installation height is larger.

5. The antenna arrangement determination device according to claim 1,
wherein the calculator estimates a channel state between the plurality of antennas and another wireless communication device in the case where the distance between the antennas is set to the candidate value and calculates spatial correlation which is the communication quality based on the estimated channel state.

6. The antenna arrangement determination device according to claim 1,
wherein the calculator calculates a transmission rate or an error rate of data with another wireless communication device in the case where the distance between the antennas is set to the candidate value as the communication quality.

7. The antenna arrangement determination device according to claim 1, further comprising
an adjuster configured to adjust the distance between the antennas based on the candidate value,
wherein the calculator calculates the communication quality by actual measurement, using the plurality of antennas for which the distance between the antennas is adjusted to the candidate value.

8. The antenna arrangement determination device according to claim 1,
wherein the calculator calculates the communication quality by simulation.

9. The antenna arrangement determination device according to claim 1, further comprising
an adjuster configured to adjust the distance between the plurality of antennas, according to the setting value of the distance between the plurality of antennas.

10. The antenna arrangement determination device according to claim 1, further comprising
a transmitter/receiver configured to perform MIMO communication through an antenna device for which the distance between the antennas is set to the setting value.

11. An antenna arrangement determination device comprising
an antenna arrangement determiner configured to determine a candidate range of a distance between a plurality of antennas according to an installation height of an arbitrary one of the antennas for which the distance between the antennas is adjustable, and determine a setting value of the distance between the antennas from the candidate range.

12. A wireless communication device comprising:
the antenna arrangement determination device according to claim 1; and
the plurality of antennas according to claim 1.

13. An antenna arrangement determination method comprising:
generating candidate values of a distance between a plurality of antennas, at an interval according to an installation height of an arbitrary one of the antennas, the distance between the antennas being adjustable;
calculating communication quality in a case of setting the distance between the antennas at the candidate values; and
determining a setting value of the distance between the antennas from the candidate values based on the communication quality.

14. A wireless communication device comprising a plurality of antennas wherein a distance between the plurality of antennas is determined by the antenna arrangement determination method according to claim 13.
